(19) United States
(12) Patent Application Publication
(10) Pub. No.: US 2011/0210066 A1
(43) Pub. Date: Sep. 1, 2011

(54) WASTE FLUID TREATMENT USING FILAMENTOUS FUNGUS OR ACTINOMYCETE

(76) Inventor: Keisuke Takenouchi, Kagoshima-shi (JP)

(21) Appl. No.: 13/034,058

(22) Filed: Feb. 24, 2011

(30) Foreign Application Priority Data
Mar. 1, 2010 (JP) 2010-043711

(51) Int. Cl. C02F 3/34

(52) U.S. Cl. 210/615

(57) ABSTRACT

The present application provides a higher grade purification method of waste fulid in decomposition of organic substances than the conventional active sludge method using monocellular microorganisms. The method includes a first step of growing a filamentous fungus and/or actinomycete on a porous or fibrous carrier made of polypropylene or polyethylene by solid fermentation. Then the carrier including the grown filamentous fungus and/or actinomycete is loaded into waste fluid for purification of the waste fluid. The carrier is preferably first soaked with a nourishing starch solution and then a filamentous fungus and/or actinomycete is grown by solid fermentation such that a hyphal membrane covers the surface of the carrier.

### BACKGROUND OF THE INVENTION

### 1. Field of the Invention

This invention relates to a technique for waste fluid treatment using a filamentous fungus or actinomycete.

Priority is claimed on Japanese Patent Application No. 2010-43711, filed Mar. 1, 2010, the content of which is incorporated herein by reference.

### 2. Description of the Related Art

A massive amount of water is consumed when a large amount of rice (polished rice) is occupationally washed. Since water is not always abundant in countries or regions, conservation of water may be necessary in certain areas. Furthermore, since rice washing discharges a large amount of wastewater (that is, waste), it is necessary to take measures for purification of the wastewater. It is necessary in large restaurants or hotels to construct facilities for treating wastewater and activated sludge and such wastewater treatment facilities place a burden including not only the building cost of the facility but also their running cost.

Conventionally, microorganisms are used for purifying wastewater. However, it has been generally accepted that multicellular microorganisms such as filamentous fungi or actinomycetes are unsuitable for wastewater treatment. The reason is that these multicellular microorganisms may grow three-dimensionally in wastewater, and grown microorganisms increase the SS (suspended substance), which results in a bulking phenomenon.

Patent Document 1, which are incorporated herein by reference, has proposed a method of treating wastewater containing fats and oils using a fixed filamentous fungus on a carrier in an immobilized state, because filamentous fungus is capable of decomposing fats and oils. In this method, immobilization of filamentous fungus onto the carrier is carried out by culturing the filamentous fungus together with the carrier in a culture fluid, that is, immobilization is performed by liquid-state fermentation (see paragraph [0081] of the Patent Document 1). When liquid-state fermentation is applied for immobilization, filamentous fungus can decompose fats and oils. However, a problem arises wherein cells of filamentous fungus are likely to be suspended in wastewater and liberated cells increase SS (suspended substances).

### Related Art Document

Patent Document 1: JP-A- Heil-303899

### SUMMARY OF THE INVENTION

Problems to be solved by the invention are as follows.

Since filamentous fungi and actinomycetes are multicellular microorganisms, if growth of these microorganisms can be properly controlled, it may be possible to provide a higher grade waste fluid purification method than the conventional wastewater purification method using activated sludge.

The present invention provides a method of waste fluid purification by loading into waste fluid a microorganism-immobilized carrier, which contains a hyphal membrane of a filamentous fungus and/or actinomycete formed by solid-state fermentation with a water-containing porous or fibrous carrier.

The present invention further provides a method of waste fluid purification by loading into the waste fluid a microorganism-immobilized carrier, which contains hyphal membranes of a filamentous fungus and/or actinomycete near the surface, wherein the hyphal membranes are formed by solid-state fermentation by coating a porous or fibrous carrier with a liquid for culturing filamentous fungi and/or actinomycetes and spores of a filamentous fungus and/or actinomycete.

In the present invention, first, a filamentous fungus or actinomycete is proliferated by solid-state fermentation in a fibrous or porous carrier made of polypropylene, polyethylene or carbon fibers including a high ratio of voids. Subsequently, the filamentous fungus or actinomycete which is immobilized in a fibrous or porous carrier is loaded into waste fluid in order to carry out efficient purification of waste fluid.

An object of the present application is to purify waste fluid by decomposition of organic substances. Thus, the present application is advantageously applicable to remove SS, especially for purification of food processing wastewater after food processing including a large amount of suspended substances such as water used to scrub polished rice, that is, rice wash, or noodle broth. The present application is characterized by carrying out immobilization of microorganism into the carrier by solid-state fermentation, not by liquid-state fermentation. For instance, immobilization is realized by coating a culture solution containing spores of a filamentous fungus or actinomycete onto porous or fibrous carrier and by fermentation. By solid-state fermentation, a hyphal membrane is formed near the surface of the carrier.

These fungi grown by solid-state fermentation are scarcely separated into single cells in water, and they grow in the fixed state on the carrier. Thus, fungi on the carrier surface will not increase SS, COD or BOD from the fungus bodies which make it possible to perform efficient purification of wastewater.

According to the method of the present application, it is possible to suppress the increase of putrid bacteria and the present application makes it possible to grow fungus which is useful for waste fluid purification such as a yeast, which can coexist with filamentous fungi and/or actinomycetes.

Besides natural proliferation, it is possible to load yeast into the waste fluid. For instance, yeast can be introduced into the waste fluid after starting a purification treatment by fixed mold. Yeast has good compatibility with molds, and yeast sticks to the mold membrane within a short period. As a result, water-soluble organic substances formed by decomposition by mold is consumed by yeast, which results in reducing BOD.

In the present application, the term “solid-state fermentation” means a filamentous fungus and/or actinomycete growing on water-containing solid carrier, and solid-state fermentation is differentiated from “liquid-state fermentation” in which a fungus grows in a liquid. The content of water contained in the solid carrier is less than 90%, preferably less than 60%, and most preferably less than 50%.

In the present application, “membrane of filamentous fungus and/or actinomycete”, “fungus film” or “hyphal membrane” means an entangled lump of mycelia formed, preferably so as to cover the surface of the carrier or extending on the surface of the carrier.

In the present application, “waste fluid” means waste fluid or wastewater containing organic substances; such as food processing waster fluid or water, e.g. rice wash, liquid for cooking noodle, or liquid for cooking grains or vegetables, and starch waste fluid. In addition, the present invention is capable of decomposing and purifying waste fluid containing active sludge or livestock manure.

### BRIEF DESCRIPRION OF THE DRAWING

FIG. 1 shows the COD change in wastewater due to a long-term treatment by incorporating a carrier having a mold membrane thereon.

### DETAILED DESCRIPTION OF THE INVENTION

Hereinafter, embodiments of the present invention will be described.

First, a porous carrier is made to contain a filamentous fungus and/or actinomycete and a liquid which is appropriate for growing the filamentous fungi and/or actinomycetes, preferably a liquid for culturing filamentous fungi and/or actinomycetes containing spores of the filamentous fungus and/or actinomycete.

Various methods can be used to soak the carrier in a liquid. The methods may includes, for example, coating or spray coating the liquid on the carrier, or immersing the carrier in an appropriate amount of liquid. A preferable method is to soak the carrier in a starch containing solution mixed with the waste fluid, and then coat the spore containing culture solution on the surface of the soaked carrier. Then the thus formed carrier is subjected to solid-state fermentation, so as to form a hyphal membrane on the carrier to prevent mycetocytes from being separated from the carrier.

A more preferable embodiment of the present application is to use a microorganism-fixed carrier, in which a porous carrier soaked with a starch solution, which is nutritious for fungi, is further coated with spores of a filamentous fungus and/or actinomycete, and then subjected to solid-state fermentation, so that the hyphal membrane is formed thereon. The solid-state fermentation is implemented by fermenting in a bath which is maintained under optimal conditions for growing fungi (temperature: 30° C.) for several days.

Subsequently, the thus formed microorganism fixed carrier is loaded into waste fluid.

It was confirmed that the above-described carrier loaded into waste fluid has showed prominent effects in suppressing separation of microorganisms from the carrier, effectively decomposing organic substances and efficiently capturing SS.

One embodiment of the present application will be described below. 1. A starch solution is soaked into a microorganism fixing carrier, such as a deodorant mat made of polypropylene; 2. A culture solution including filamentous fungi such as Aspergillus oryzae is coated on the starch containing carrier; 3. The carrier having amplified filamentous fungus is vertically held in the fluid, and the fluid is stirred with aeration.

Examples of embodiments of the present application shall be described below: Embodiment 1. A method of purifying waste fluid including: adding a microorganism-immobilized carrier to the waste fluid, wherein the microorganism-immobilized carrier contains a water-containing porous or fibrous carrier and a hyphal membrane of a filamentous fungus and/or actinomycete, preferably near or on the surface of the water-containing porous or fibrous carrier, grown by solid-state fermentation.

Embodiment 2. The method according to Embodiment 1, wherein the microorganism-immobilized carrier is prepared by coating a) a liquid for culturing filamentous fungi and/or actinomycetes and b) spores of the filamentous fungus and/or actinomycete on the porous or fibrous carrier and by growing the hyphal membrane of the filamentous fungus and/or actinomycete on the porous or fibrous carrier by solid-state fermentation.
Embodiment 3. The method according to Embodiment 2, wherein the microorganism-immobilized carrier is prepared by coating a liquid for culturing filamentous fungi and/or actinomycetes, which comprises spores of the filamentous fungus and/or actinomycete, on the porous or fibrous carrier and by growing the hyphal membrane of the filamentous fungus and/or actinomycete on the porous or fibrous carrier by solid-state fermentation.
Embodiment 4. The method according to any one of Embodiments 1 to 3, wherein the filamentous fungus and/or actinomycete is a filamentous fungus. Embodiment 5. The method according to any one of Embodiments 1 to 4, wherein purification of the waste fluid comprises removal of SS.

Microorganisms used in the present invention are limited to filamentous fungi and actinomycetes. Preferable species includes Aspergillus , Ryzopus, and Mucor. More favorable species includes Aspergillus niger, Aspergillus sojae, and Aspergillus awamori, and the most favorable one is Aspergillus niger. It is possible to use a yeast in addition to a filamentous fungus and/or actinomycete. Yeast can be directly incorporated into waste fluid.

A carrier such as a porous carrier or a fibrous carrier may be used in the present application if the carrier is capable of fixing fungi. The materials of the carrier include polypropylene or polyethylene.

The shape of the carrier is preferably a plate or mat-shape. The carrier is preferably wrapped in a bag or held in a waste fluid treatment tank. By fixing the carrier it becomes possible to prevent the carrier from flowing off or blocking the discharge port of the tank. In order to fix the carrier, the carrier is enwrapped in a rough net or is pinched in the tank.

It is possible to implement purification of waste fluid by aeration during the purification treatment. The microorganism fixed carrier of the present application can be used in a temporary storage tank. The microorganism fixed carrier is particularly effective when such a carrier is used for purifying rice wash or restaurant wastewater which is required to reduce SS or BOD.

### [Example 1]

### Rice Wash Treatment Test

100 mg of spores of Aspergillus niger were mixed with 100 ml of a pasteurized liquid for culturing (containing 5% of glucose and 0.5% of yeast essence) and the mixture was coated on one liter of polypropylene carrier. The thus formed coated carrier was fermented for three days at a temperature of 30° C. After three days of fermentation, spores of Aspergillus niger form a fungus body on the polypropylene carrier.

One liter of the thus formed carrier with the fungus body is introduced into 5 liters of rice wash solution (COD 800 ppm; turbidity 1.5) and aeration is performed at a rate of 5 liters per minute.

A control test was conducted by directly loading 5g of Aspergillus niger spores and 1 liter of polypropylene into 5 liter of rice wash and performing aeration at a rate of 5 liters per minute.

The results after 24 hours are shown in Table 1.

Purification Treatment of rice washes by Aspergillus niger

TABLE 1

| | Before | Immobilized fungus | Direct introduction |
|---|---|---|---|
| | introduction | Introduction | of fungus spore |
| | of fungus | (present invention) | (reference test) |
| COD | 800 ppm | 80 ppm | 1050 ppm |
| Turbidity | 1.5 | 0.015 | 1.3 |

As clearly shown in the above table, a test according to the present application using a fungus body of Aspergillus niger showed that the COD value drastically decreased to 80 ppm after 24 hours. In contrast, when spores of Aspergillus niger is directly charged, the COD value increased.

Moreover, in contrast to the turbidity being reduced to 0.015 in the present application, the control test showed that the turbidity remains at the same level.

The above-described results indicate that the filamentous fungus mainly grows inside of the polypropylene carrier, so fungus cells are not liberated into wastewater.

### [Example 2]

### Active Sludge Treatment

A test was conducted to carry out purification for active sludge collected from a water purifying tank installed at a food processing factory. A carrier which contains a culture medium for actinomycetes and active carbon was used, and the water content of the culture medium is adjusted to 40% and then it was solid-state fermented for five days at 35° C. In this test section, 1 ml of the immobilized fungus body was added to lliter of the active sludge, and aerial culture was carried out for 10 days at 30° C.

In contrast, as a control section a solution was used in which actinomycete was added to a culture medium and aerial culturing was conducted for five days at a temperature of 35° C. In the control section, 1 ml of the culture solution was added to 1 liter of active sludge and aerial culturing was performed.

In the following table, changes in the volume of the active sludge are shown.

Volume reduction of activated sludge by actinomycetes

TABLE 2

| | 1 day | 2 days | 3 days | 4 days | 5 days | 6 days | 7 days | 8 days | 9 days | 10 days |
|---|---|---|---|---|---|---|---|---|---|---|
| Test | 100% | 80% | 75% | 75% | 73% | 73% | 50% | 45% | 40% | 30% |
| section | | | | | | | | | | |
| (present | | | | | | | | | | |
| invention) | | | | | | | | | | |
| Reference | 100% | 95% | 94% | 94% | 92% | 91% | 90% | 80% | 83% | 79% |
| section | | | | | | | | | | |

As shown in the Table 2, when the active sludge is treated by a fixed fungus body which is formed by solid-state fermentation of the actinomycete, the active sludge can be digested at a speed twice greater than the control section in which the fungus is simply added to the active sludge.

### [Example 3]

### Processing of Soybean Broth

A test was conducted to process the soybean broth discharged from a natto (made of soybeans) factory. A sponge carrier was immersed in soybean broth and the water content in the carrier is adjusted to 40%, and then the sponge carrier was solid-state fermented with Ryzopus for three days at 30° C. In the test section of the present application, 100m1 of the fungus body was added to one liter of soybean broth, and an aerial culture was performed for three days at 30° C.

As a control test, a cultured solution was used in which Ryzopus was subjected to a vibrating culture for three days at 30° C. In the control section, 10 ml of the culture solution was loaded in 1 liter of soybean broth.

The test result using the sponge carrier indicated that the initial 50000 ppm of COD decreased to 3000 ppm. In contrast, in the control section showed that the COD remained at a value of 43000 ppm, showing the change was slight.

### [Example 4]

### Treatment of Fowl Droppings

Water was added to fowl droppings and the solution was prepared after adjusting the water content to 90% and pasteurized.

Then, 0.1% of Mucor spores were suspended in the solution and the suspended solution was coated on the fibrous polypropylene and a fixed fungus body formed on the fibrous carrier was prepared after solid-state culturing for 5 days at 30° C.

As a control test section, a cultured solution was prepared by adding 0.1% of Mucor spores to the fowl dropping solution and by vibration culturing for 3 days at 30° C.

In the test section of the present application, the above-described fixed fungus body was added to one liter of fluid in which water was added to the fowl droppings and the water content was adjusted to 90% (not pasteurized) and aerial culturing was carried out for 5 days at 30° C.

The result at the test section showed that the Mucor in the polypropylene increased extensively, and the turbidity of the solution was reduced to 0.1. In addition, COD was from 48000 ppm to 150 ppm.

In the control section, the turbidity showed a small change from 1.8 to 1.75, and COD rather increased from 48000 ppm to 51000 ppm.

### [Example 5]

Comparison of purification ratio of the rice wash between the case of direct loading of malt and the case of loading the malt membrane formed carrier

TABLE 3
Simple culturing case (control)

| | Niger | Oryzae | sojae | awamori |
|---|---|---|---|---|
| COD: 0 hr | 1459 | 1511 | 1380 | 1712 |
| COD 22 hr | 1529 | 1208 | 1258 | 1128 |
| Digestion ratio | −4.8% | 20.1% | 8.8% | 34.1% |

Malt membrane (the present invention)

| | Niger | Oryzae | Sojae | Awamori |
|---|---|---|---|---|
| COD: 0 hr | 959 | 1614 | 1114 | 1449 |
| COD: 22 hr | 96 | 636 | 100 | 50 |
| Digestion ratio | 90.0% | 60.6% | 8.8% | 96.5% |

The simple culturing case in the upper table showed the change of COD when 0.1% of seed malt was loaded into rice wash and then the solution was aeration cultured.

The malt film case in the lower table indicates the change of digestion ratio for rice wash soaked in a sponge carrier including a malt membrane after being subjected to aerial culturing.

It was clearly revealed that rice wash can not be purified only by adding malt, and simple addition of malt rather increases the value of COD vice versa. In addition, it is not possible to purify rice wash by adding a sponge carrier including malt if the sponge carrier including fixed malt is obtained by soaking the carrier in a malt culture solution, that is, a carrier containing malt fixed by liquid fermentation. That is because malt cells are liberated into the solution to be treated.

In contrast, when a sponge carrier has a malt hyphal membrane by solid-state fermentation, it is possible to decompose the organic substances by 60% over 22 hours.

Furthermore, the most preferable malts for carrying out the present application include Aspergillus niger, Aspergillus sojae and Aspergillus awamori.

### [Example 6]

Long-term purification treatment by addition of a malt-film formed carrier

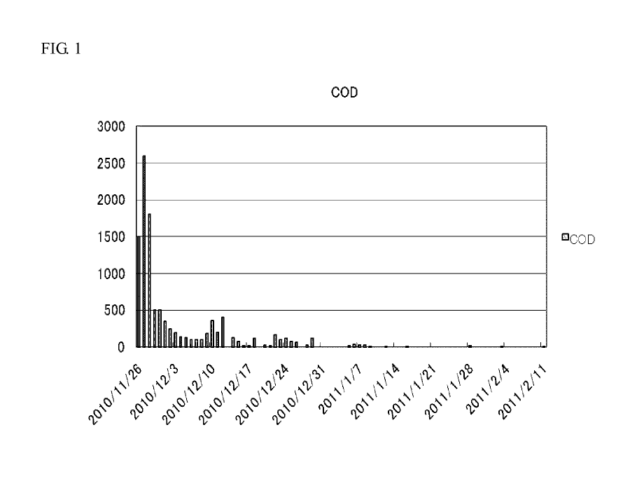

A noodle broth discharged daily at an amount of 20 t is continuously treated in a large scale facility having a temperature maintaining and aeration capability provided with a malt fixed fungus carrier. The daily change of COD values is shown below, and the graph showing the daily change is illustrated in FIG. 1.

TABLE 4

| Date | COD |
|---|---|
| Nov. 26 | 1500 |
| Nov. 27 | 2600 |
| Nov. 28 | 1800 |
| Nov. 29 | 500 |
| Nov. 30 | 500 |
| Dec. 1 | 350 |
| Dec. 2 | 250 |
| Dec. 3 | 190 |
| Dec. 4 | 140 |
| Dec. 5 | 130 |
| Dec. 6 | 100 |
| Dec. 7 | 100 |
| Dec. 8 | 100 |
| Dec. 9 | 180 |
| Dec. 10 | 360 |
| Dec. 11 | 200 |
| Dec. 12 | 400 |
| Dec. 14 | 125 |
| Dec. 15 | 70 |
| Dec. 16 | 20 |
| Dec. 17 | 20 |
| Dec. 18 | 120 |
| Dec. 20 | 30 |
| Dec. 21 | 17 |
| Dec. 22 | 160 |
| Dec. 23 | 100 |
| Dec. 24 | 120 |
| Dec. 25 | 70 |
| Dec. 26 | 60 |
| Dec. 28 | 26 |
| Dec. 29 | 120 |
| Jan. 5 | 20 |
| Jan. 6 | 35 |
| Jan. 7 | 30 |
| Jan. 8 | 30 |
| Jan. 9 | 12 |
| Jan. 12 | 12 |
| Jan. 16 | 13 |
| Jan. 28 | 20 |
| Feb. 3 | 9 |
| Feb. 11 | 13 |

The wastewater having a COD value of 1200 ppm was purified into about 10 ppm after 24 hours.

In addition, since so many fungi exist in the wastewater and in air, it is understood that the other fungi (yeasts etc.) start coexisting, so that the purification capability drastically improved after approximately about one month of operation.

What is claimed is:

1. A method of purifying waste fluid comprising:
adding a microorganism-immobilized carrier to the waste fluid, wherein the microorganism-immobilized carrier comprises a water-containing porous or fibrous carrier and a hyphal membrane of a filamentous fungus and/or actinomycete grown by solid-state fermentation.

2. The method according to claim 1, wherein the microorganism-immobilized carrier is prepared by coating a) a liquid for culturing filamentous fungi and/or actinomycetes and b) spores of the filamentous fungus and/or actinomycete on the porous or fibrous carrier and by growing the hyphal membrane of the filamentous fungus and/or actinomycete on the porous or fibrous carrier by solid-state fermentation.

3. The method according to claim 2, wherein the microorganism-immobilized carrier is prepared by coating a liquid for culturing filamentous fungi and/or actinomycetes, which comprises spores of the filamentous fungus and/or actinomycete, on the porous or fibrous carrier and by growing the hyphal membrane of the filamentous fungus and/or actinomycete on the porous or fibrous carrier by solid-state fermentation.

4. The method according to claim 1, wherein the filamentous fungus and/or actinomycete is a filamentous fungus.

5. The method according to any one of claims 1 to 4, wherein purification of the waste fluid comprises removal of SS.
